(19) United States
(12) Patent Application Publication
(10) Pub. No.: US 2013/0323137 A1
(43) Pub. Date: Dec. 5, 2013

(54) POWER SUPPLY ARRANGEMENT WITH AN INVERTER FOR PRODUCING N-PHASE AC CURRENT

(71) Applicant: AEG POWER SOLUTIONS B.V., Zwanenburg (NL)

(72) Inventor: Andreas Averberg, Bonn (DE)

(73) Assignee: AEG Power Solutions B.V., Zwanenburg (NL)

(21) Appl. No.: 13/765,143

(22) Filed: Feb. 12, 2013

(30) Foreign Application Priority Data
Jun. 1, 2012 (EP) 12 170 485.2

(51) Int. Cl. B01J 8/02; H02M 5/458

(52) U.S. Cl. CPC B01J 8/0285; H02M 5/458
USPC 422/199; 307/31

(57) ABSTRACT

A power supply arrangement (MF) with an inverter (12) for generating N-phase AC current and at least one N-phase AC current transformer (2) having primary windings (211, 212, 213) and secondary windings (221, 222, 223), wherein the primary windings (211, 212, 213) are connected in a polygon and a sum vector of the voltages present at the N secondary windings (221, 222, 223) becomes zero when the transformer is idling, wherein each vertex of the polygon formed by the primary windings (211, 212, 213) is connected via a corresponding capacitor (C11, C12, C13) with a corresponding phase conductor terminal of the inverter (12).

This application claims priority to EP 12 170 485.2 filed on Jun. 1, 2012.

### BACKGROUND OF THE INVENTION

The present invention relates to a power supply arrangement with an inverter for producing N-phase AC current and at least one N-phase AC current transformer having primary and secondary windings, wherein the primary windings are connected in a polygon and a sum vector of the voltages applied to the N secondary windings becomes zero in idle mode of the transformer.

Such power supply arrangement is known from the unpublished European Patent Application Serial No. 11 174 546.9 (see FIG. 1, which is taken from the application 11 174 546.9). It is known from the same application 11 174 546.9 to use this first power supply arrangement for supplying power to silicon rods for producing polysilicon according to the Siemens process. The power supply arrangement shown in the aforementioned application 11 174 546.9 has three outputs producing voltages having an phase shift of 120° relative to each other. These voltages supply medium frequency currents with a frequency between 1 and 1000 kHz to the silicon rods. The voltages are provided by a three-phase AC transformer having three primary windings and three secondary windings. The primary windings are connected in a Delta configuration. In idle mode of the transformer, a sum vector of the voltages present at the three secondary windings is zero.

The three secondary windings are connected in series and are parallel to three outputs of the current supply arrangement. Loads in the form of silicon rods are connected to the outputs, through which the power supply arrangement drives a current.

In addition to the power supplied from the first power supply arrangements, power can be supplied to the silicon rods from a second power supply arrangement at the same time when power is supplied from the first power supply arrangements, as described in the aforementioned application 11 174 546.9. The silicon rods are connected in series to this second power supply arrangement. The power is supplied by a current having a frequency of about 50 Hz.

The application 11 174 546.9 describes that the second power supply arrangement is decoupled from the first power supply arrangements in that the voltage across the series-connected outputs of the first power supply arrangements is equal to zero.

In practice, however, problems may arise when the load at the outputs of a first power supply arrangement does not have identical magnitude. Especially when the inductance of one load is greater than the inductance of the other load, significant differences in the magnitudes of the voltages supplied at the outputs of the first power supply assemblies may arise. As a result, the sum of the voltages across the outputs of the first power supply arrangement is then no longer 0V. Instead, magnitudes of more than 100 V are reached. The attained voltage may depend on the frequency at which the first power supply arrangement is operated.

This unbalanced loading of the first power supply arrangement and the resulting voltage across the series-connected outputs of the first power-supply arrangement may lead to damage or destruction of the second power supply arrangement.

### BRIEF SUMMARY OF THE INVENTION

It is therefore an the object of the invention to improve a first power supply arrangement so as to eliminate differences between the magnitudes of the voltages at the outputs of an aforementioned first power-supply arrangement as much as possible.

This object is attained according to the invention in that each vertex of the polygon formed by the primary windings is connected to a phase conductor terminal of the inverter by way of a corresponding capacitor.

The capacitors connecting the vertices of the polygon to the phase conductor terminals are indirectly, i.e. through interposition of the transformer, arranged in the circuit of two loads during the operation of the power supply arrangement. The capacitors can hence equalize the absolute difference between the voltages at the outputs of the power supply arrangement. The capacitors may have a capacitance of 4 to 6 μF, in particular 4.5 μF. The capacitors on the primary side may have a capacitance and a rated voltage that is different from that of the capacitors on the secondary side. Typical capacitance values for capacitors on the secondary side may range from 2 μF to 10 μF.

The outputs of the power supply arrangement are preferably arranged parallel to the secondary windings.

Advantageously, the outputs of the power supply arrangement may also be arranged parallel to series circuits, wherein each series circuit is composed of one of the secondary windings and an additional capacitor. With the additional capacitors, the power supply arrangement according to the invention, also referred to below as the first power supply arrangement, may be decoupled from a second power supply arrangement arranged parallel to a series connection of the outputs of the first power supply arrangement. These additional capacitors in conjunction with additional components form high pass filters, which prevent current driven by the second power supply arrangement and having a low frequency compared to the output currents of the first power supply arrangement from flowing into the first power supply assemblies and damaging or destroying the first power supply assemblies.

The voltage across all outputs of the first power supply arrangement with an unbalanced load can be reduced by using this type of decoupling of the first power supply arrangement from the second power supply arrangement. However, the reduction is then not as noticeable as when these capacitors at the phase conductor terminals are eliminated.

The object can also be attained according to the invention when the voltage across at least N−1 secondary windings is discretely or continuously adjustable. A discrete adjustability of the voltage can be achieved when the secondary windings have several taps. When the voltage is adjustable across secondary windings N−1, it can be changed so that the voltages across the loads connected to the power supply arrangement according to the invention are substantially equal.

According to another solution of the invention, at least N−1 capacitors of the capacitors connected in series with the secondary windings have a variable capacitance. Such adjustable capacitors may result in substantially equal voltages across the loads connected to the power supply arrangement according to the invention.

The inverter may be a bridge circuit with power transistors.

The power supply arrangement may include an inverter, and the inverter may be part of the frequency converter. The frequency converter may include a rectifier and a DC link circuit in addition to the inverter.

Alternatively, the frequency converter may also be a direct converter. The inverter within the context of this application is then an integral part of the direct converter.

The power supply arrangement according to the invention may be part of reactor for producing polysilicon according to the Siemens process. The power supply arrangement according to the invention may be a first power supply arrangement for supplying power to silicon rods or thin silicon rods in form of AC current for the inductive heating. The silicon rods or thin silicon rods may be arranged in a reactor vessel. Holders with which the silicon rods or thin silicon rods are held are provided inside the reactor vessel. The holders are also electrical connections, with which the silicon rods or the thin silicon rods are integrated into the load circuit.

The reactor may include a second power supply arrangement for supplying power to the silicon rods or thin silicon rods in form of AC current for inductive heating. This second power supply arrangement may include a transformer having a plurality of secondary-side taps and power controllers connected thereto, which are operated in voltage sequence control and are connected to a phase conductor terminal of an output of the second power supply arrangement, as also disclosed, for example, in FIG. 1. A frequency of the AC current that can be generated by the first power supply arrangement is between 1 to 1000 kHz, and a frequency of the AC current that can be generated by the second power supply arrangement is 1 to 100 Hz

Additional features of the invention will become apparent from the following description of preferred exemplary embodiments with reference to the appended drawings, which show in:

### BRIEF DESCRIPTION OF THE DRAWINGS

FIG. 1 a circuit diagram of an arrangement according to the prior art composed of a first power supply arrangement and a second power supply arrangement,

FIG. 2 a diagram of a first power supply arrangement according to the invention, and

FIG. 3 a diagram of a second power supply arrangement according to the invention.

### DETAILED DESCRIPTION OF THE INVENTION

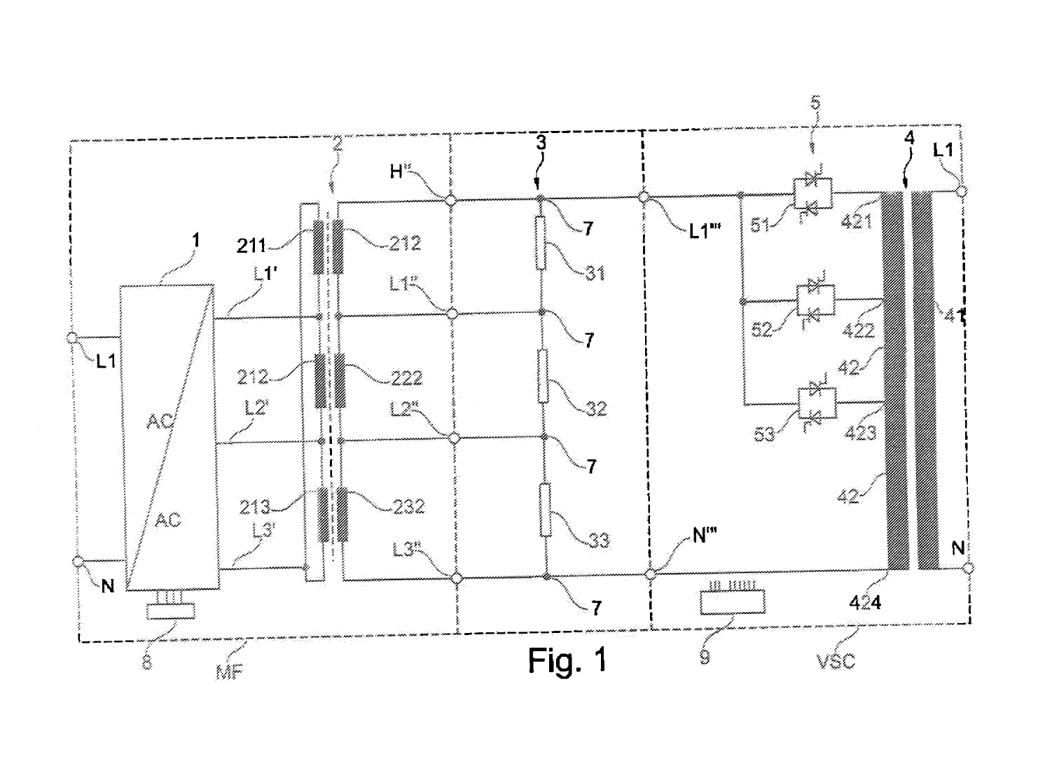

The inventive arrangement shown in FIG. 1 includes a first power supply arrangement VSC and a second power supply arrangement MF, which are provided together to supply electrical energy to loads connected to the arrangement. The loads are silicon rods 3, which are mounted in a reactor for producing polysilicon by vapor deposition according to the Siemens process.

Holders 7 are mounted in a reactor vessel of the reactor which, on one hand, hold the silicon rods 3 and, on the other hand, create an electrical contact between the silicon rods 3 and electrical terminals of the reactor.

The first power supply arrangement MF has an input which is connected to a phase conductor L1 and a neutral conductor N of the one connected single-phase AC system, for example a second power supply arrangement VSC. The first power supply arrangement MF has an AC-AC converter 1 which is connected to the input of the second power supply arrangement MF.

The AC-AC converter 1 may be a matrix converter which converts the single-phase AC current at the input of the AC-AC converter 1 at a frequency of 50 to 60 Hz into a three-phase AC current with a frequency of 20 to 200 MHz. The AC-AC converter 1 is then at the same time a circuit for converting the input current into the three-phase AC currents and a frequency converter. The three-phase AC currents are supplied at three phase conductors L1′, L2′, L3′ at the output of the AC-AC converter 1.

The output of the AC-AC converter 1 is connected to a three-phase AC transformer 2 having primary windings 211, 212, 213 connected in a Delta configuration. The secondary windings 212, 222, 232 are connected to terminals H″, L1″, L2″, L3″ which in pairs form outputs of the second current supply arrangements MF. The silicon rods 3 are connected to these outputs, wherein a first silicon rod 31 is connected to the terminals H″, L1″ forming a first output, a second silicon rod 32 is connected to the terminals L1″, L2″ forming a second output, and a third silicon rod 33 is connected to the terminals L2″, L3″ forming a third output of the second power supply arrangement MF. Due to the phase angle of 120° between the phase conductors, no voltage drop occurs between the terminal H″ and the terminal L3″ for balanced loading by the silicon rods 31, 32, 33.

The AC-AC converter 1 is controlled by a controller 8, which is not shown in detail.

Basically, the terminals H″ and L3″ could be connected without affecting the second power supply arrangement MF. The secondary windings 31, 32, 33 would then be connected in a Delta configuration. However, a connection between these two terminals H″ and L3″ is not established, because this connection would also short-circuit the outer conductor terminal L1″ and the neutral conductor N′″ of the second power supply arrangement VSC, which is not desirable.

Because there is no voltage drop between the terminals H″ and L3″ of the second power supply arrangement MF and consequently there is also no voltage drop of a voltage provided by the first power supply arrangement MF between the terminals L1′″, N′″ of the output of the second power supply arrangement VSC, the second power supply arrangement MF is unable to drive current into the first power supply arrangement VSC with balanced loading by the silicon rods 31, 32, 33.

The second power supply arrangement VSC has an input which is connected to a phase conductor L1 and a neutral conductor N of a single-phase AC system. The second power supply arrangement VSC has a single-phase AC current transformer 4 with a primary winding 41 connected to the input of the second power supply arrangement VSC. A secondary winding 42 of the transformer 4 has four taps 421, 422, 423, 424, wherein three of these taps 421, 422, 423 are connected to via power controllers 51, 52, 53 to a phase conductor terminal L1′″ of an output of the second power supply arrangement VSC. The fourth tap 424 is connected, on the other hand, with a neutral conductor terminal N′″ of the output of the second power supply arrangement VSC. The fourth tap 424 is disposed on one end of the secondary winding 42.

The power controllers 51, 52, 53 are thyristor power controllers formed by two antiparallel connected thyristors. The power controllers 51, 52, 53 are operated in voltage sequence control.

The voltage sequence control is realized with a controller 9 which is connected to the thyristors of the power controllers 51, 52, 53 and additional devices and/or sensors to be controlled for detecting current, voltage, and the like, which is not shown in detail.

To prevent feedback from the second power supply arrangement VSC to the first power supply arrangement MF, high pass filters may be installed in the outputs of the first power supply arrangement MF, which block the output voltage of the first voltage supply arrangement VSC.

The arrangement shown in FIG. 1, in particular the first power supply arrangement MF, can be expanded for connecting more silicon rods to more outputs. Instead of an AC-AC converter having a single output for a three-phase AC current system, an AC-AC converter may be employed which provides an output of a multi-phase AC system with more than three phases, for example for a four-, five- or six-phase AC current system.

The first power supply arrangement could also be expanded by using two three-phase AC current transformers 2 having primary windings connected in parallel in pairs and secondary windings connected in series.

The first power supply arrangement MF supplies at its output L1″, L2″, L3″, H″ three voltages which are phase-shifted by 120° relative to each other and which have identical magnitude in idle and with symmetric loading of the outputs L1″, L2″, L3″, H″. The voltage between the terminals L3″ H″ is then 0 V.

The effective voltages at the terminal of the output L1″, L2″, L3″, H″ may be different due to asymmetric loading of the terminals of the output L1″, L2″, L3″, H″. The voltage between terminals L3″, H″ is then not 0 V. The magnitude of the deviation may vary depending on the frequency of the AC voltage at the outputs and depending on the type of load, which may pose problems for integrating the first power supply arrangement MF into a larger facility. The AC voltages can diverge during operation of the first power supply arrangement in particular with different inductive loading. Large voltages may be generated between the terminals L3″, H″ in particular when the first power supply arrangement produces AC voltages having frequencies close to the resonance frequencies of the output circuits.

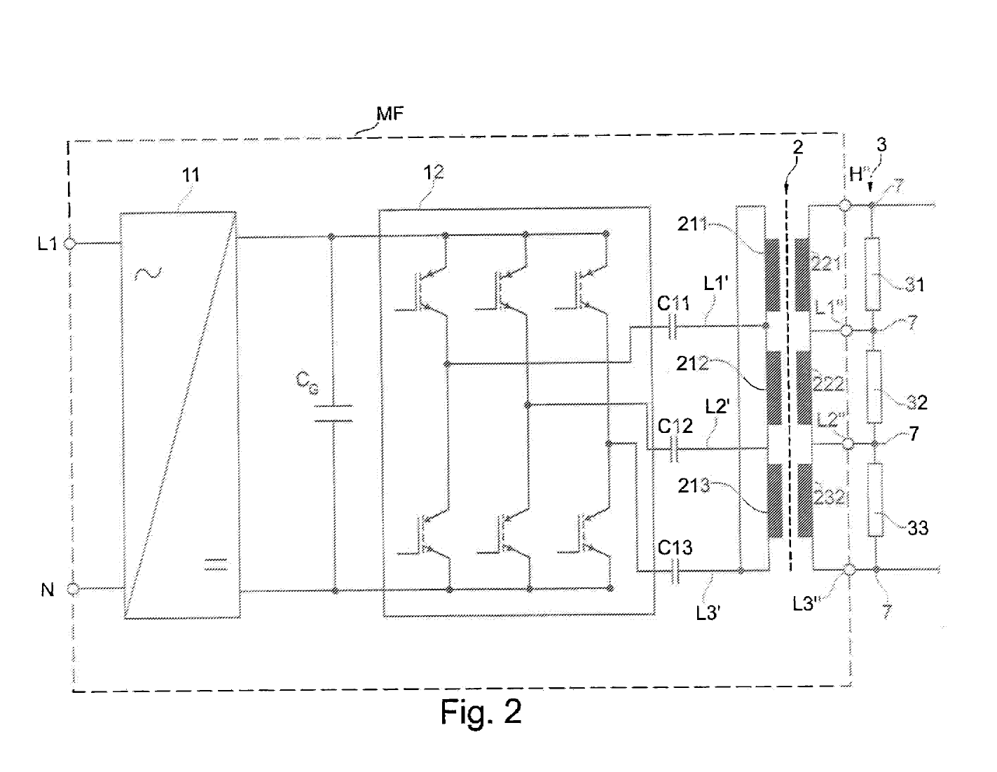

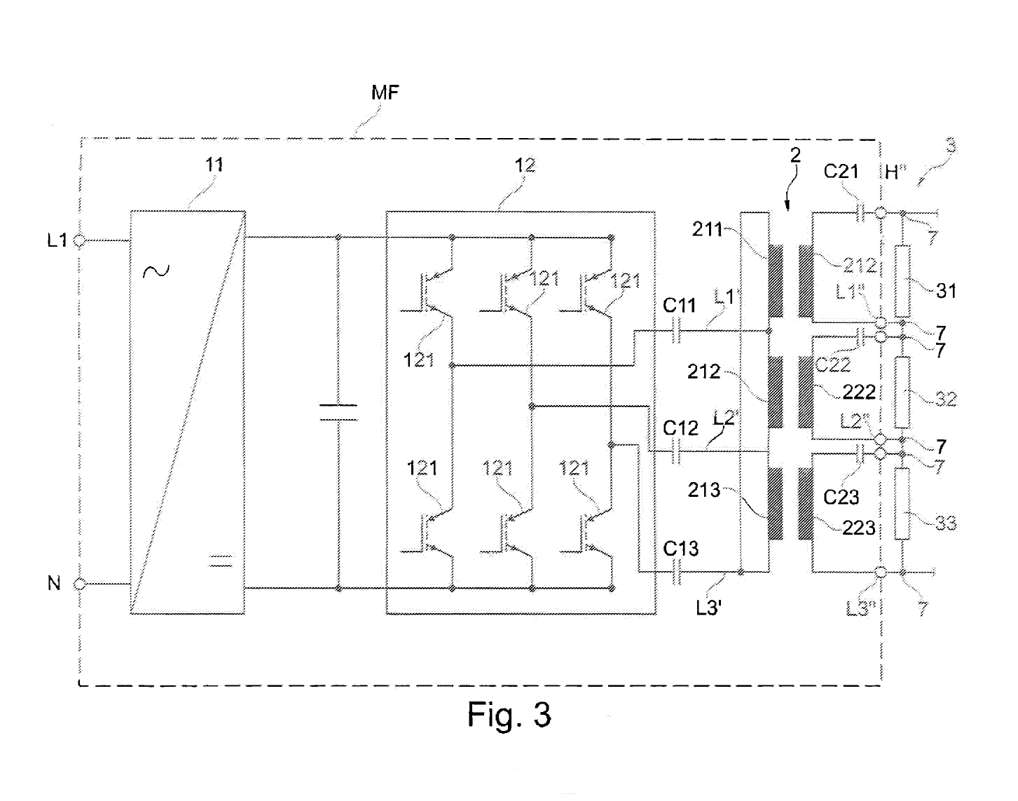

According to the invention, corresponding capacitors C11, C12, C13 may be connected between the output terminals of the AC-AC converter 1 and the vertices of the Delta-connected primary windings 211, 212, 213. First power supply arrangements MF according to the invention are shown in FIGS. 2 and 3.

The first power supply arrangements MF shown in FIGS. 2 and 3 correspond largely to the power supply arrangement MF shown in FIG. 1. Functionally identical elements and components are therefore designated by like reference symbols. The second power supply arrangement VSC is not shown in FIG. 2. However, the second power supply arrangement VSC may be connected to the loads 31, 32, 33 in the same way as the arrangement shown in FIG. 1 and FIG. 2.

FIGS. 2 and 3 show the AC-AC converter 1 is in more detail. The AC-AC converter 1 is a frequency converter 1 with a rectifier 11, a DC link circuit with a capacitor CG and an inverter 12.

The rectifier 11 is connected to a phase conductor L1 and a neutral conductor N of a supply grid. The capacitor CG forming the DC link circuit is connected to the output of the rectifier. The inverter 12 is connected to the DC link circuit.

The inverter 12 is an H-bridge composed of converter valves, in particular IGBTs 121, common in many inverters. Other controllable switches may be used instead of IGBTs. Points between the converter valves 121 of the half-bridges of the H-bridge form terminals of an output of the inverter 12. The capacitors C11, C12, C13 are connected to these terminals. The capacitors C11, C12, C13 are connected to the vertices L1′, L2′, L3′ of the Delta configuration formed by the primary windings 211, 212, 213 of the three-phase AC transformer 2. The secondary-side circuit of the three-phase AC current transformer 2 and the loads 31, 32, 33 connected thereto does not differ from the circuit shown in FIG. 1.

The voltage between terminals L3″, H″ caused by asymmetric loading can be significantly reduced with the capacitors C11, C12, C13.

The capacitors C11, C12, C13 cause coupling of the output circuits on the primary side, which reduces the voltage between the terminals L3″, H″. The voltages at the terminals L3″, H″ are equalized compared to the situations described with reference to FIG. 1 for asymmetric loading. The voltages can be reduced by up to about 100%.

The voltage between the phase conductors can be reduced by almost 80% for asymmetric loading, in particular for asymmetric resistive-inductive loading of the output of the first power supply arrangement MF through incorporation of capacitors C21, C22 and C23 in the connections between the secondary windings 212, 222, 232 of the transformer 2 and the terminals L1″, L2″, L3″, H″, as shown in FIG. 3 for the second circuit arrangement according to the invention, which corresponds in all aspects to the first circuit arrangement according to the invention illustrated in FIG. 2. Although these additional capacitors C21, C22 and C23 prevent complete balancing of the output voltages, the first power supply arrangement MF can be decoupled from the second power supply arrangement VSC.

What is claimed is:

1. A power supply arrangement (MF)comprising
an inverter (12) for generating N-phase AC current and at least one N-phase AC current transformer (2) having primary windings (211, 212, 213) and secondary windings (221, 222, 223), wherein the primary windings (211, 212, 213) are connected in a polygon and a vector sum of the voltages present at the N secondary windings (221, 222, 223) becomes zero when the transformer (2) is idling, wherein
each vertex of the polygon formed by the primary windings (211, 212, 213) is connected via a corresponding capacitor (C11, C12, C13) with a corresponding phase conductor terminal of the inverter,
the voltage across at least N−1 secondary windings (221, 222, 223) is discretely or continuously adjustable, and/or capacitors are provided in series with the secondary windings (221, 222, 223), wherein at least N−1 of the capacitors have an adjustable capacitance.

2. The power supply arrangement (MF) according to claim 1, wherein the outputs of the power supply arrangement (MF) are arranged parallel to the secondary windings (221, 222, 223).

3. The power supply arrangement (MF) according to claim 2, wherein the outputs of the power supply arrangement (MF) are arranged parallel to series-connected circuits, with each series-connected circuit being formed from one of the secondary windings (221, 222, 223) and one capacitor (C21, C22, C23).

4. The power supply arrangement (MF) according to claim 1, wherein the inverter (12) is an H-bridge with power transistors (121).

5. The power supply arrangement (MF) according to claim 1, wherein the power supply arrangement comprises a frequency converter (11, 12, CG), and the inverter (12) is part of the frequency converter (11, 12, CG)

6. A reactor for producing polysilicon according to the Siemens process, with a first power supply arrangement (MF) for the supplying power to silicon rods or thin silicon rods, which are arranged inside a reactor vessel, in form of AC current for inductive heating, wherein the first power supply arrangement (MF) is a power supply arrangement according to claim 1.

7. The reactor according to claim 6, wherein the reactor comprises a second power supply arrangement (VSC) for supplying power to the silicon rods or thin silicon rods in form of AC current for inductive heating, wherein a frequency of the AC current that can be produced by the first power-supply arrangement is 10 to 100 Hz and a frequency of the AC current that can be produced by the second power-supply arrangement is 10 to 1000 kHz.
